(19) United States
(12) Patent Application Publication
(10) Pub. No.: US 2011/0047102 A1
(43) Pub. Date: Feb. 24, 2011

(54) VEHICLE BATTERY CHARGING SYSTEM AND METHOD

(75) Inventors: Duane M. Grider, Farmington Hills, MI (US); Bruce Carvell Blakemore, Plymouth, MI (US); Julie D'Annunzio, Livonia, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/838,828

(22) Filed: Jul. 19, 2010

Related U.S. Application Data
(60) Provisional application No. 61/234,924, filed on Aug. 18, 2009.

(51) Int. Cl. G06F 17/00; H02J 7/00

(52) U.S. Cl. 705/412; 320/109; 180/65.21

(57) ABSTRACT

A vehicle may include at least one controller and a battery configured to be selectively charged with energy from an off-board energy source. The at least one controller may be configured to receive user input specifying a cost minimization mode of battery charging. The at least one controller may be further configured to, in response to the input, determine a time period available for charging the battery, determine when, during the time period, a cost of energy from the off-board energy source is at a minimum or below a threshold cost, and cause the battery to be charged during at least a portion of the time period when the cost is at the minimum or below the threshold cost to minimize the cost of charging the battery.

### CROSS-REFERENCE TO RELATED APPLICATION

This application claims the benefit of U.S. provisional application Ser. No. 61/234,924, filed Aug. 18, 2009, the contents of which are hereby incorporated in their entirety by reference.

### STATEMENT REGARDING FEDERALLY SPONSORED RESEARCH OR DEVELOPMENT

This invention was made with government support under DE-FC26-08NT04384 awarded by the Department of Energy. The government has certain rights in the invention.

### BACKGROUND

A plug-in hybrid electric vehicle (PHEV) and battery electric vehicle (BEV) may be powered by an electric machine. An on-board battery may store energy for use by the electric machine and be charged with energy from a utility grid or other off-board energy source. The cost of energy from the utility grid may change depending on the time of day. The originating source of the energy (e.g., coal, green energy, such as wind) from the utility grid may also change depending on the time of day.

### SUMMARY

A method for charging a vehicle battery with energy from an off-board energy source may include the step of receiving input specifying a cost minimization mode of battery charging. The method may also include, in response to the input, the steps of determining a time period available for charging the battery, determining when, during the time period, a cost of energy from the off-board energy source is at a minimum or below a threshold cost, and causing the battery to be charged during at least a portion of the time period when the cost is at the minimum or below the threshold cost to minimize the cost of charging the battery.

A method for charging a vehicle battery with energy from an off-board energy source may include the step of receiving user input specifying a green energy mode of battery charging. The method may also include the steps of determining a time period available for charging the battery, determining when, during the time period, energy available from the off-board energy source is identified as being green energy, and causing the battery to be charged during a least a portion of the time period when the energy available from the off-board energy source is identified as being green energy.

### BRIEF DESCRIPTION OF THE DRAWINGS

FIG. 1 is a block diagram of portions of an example alternatively powered vehicle.

Figure is an illustration of an example user interface for the vehicle of FIG. 1.

FIGS. 3A and 3B are flow charts depicting an example battery charging control algorithm.

### DETAILED DESCRIPTION

Faced with increasing environmental and regulatory pressures, utility companies are using price as a way to encourage responsible energy use. Utility pricing, however, may change over the course of a day. For example, utility price tables can vary from 1 cent to 80 cents per kilowatt hour in a single 24 hour period.

Certain embodiments described herein provide a battery charge optimizer feature that enables a user to, for example, customize battery charging based on user and utility inputs. The optimizer may allow each user to use utility provided pricing information and energy generation source information (via a smart grid interface, for example) to establish a desired optimized battery charge profile based on the user's wants and needs.

Three example battery charge optimization choices, in certain embodiments, may be provided: 1) cheapest charge, 2) greenest charge, and 3) fastest charge. In certain cheapest charge embodiments, the vehicle charge time may be based on the cost of electricity. As an example, electricity rates (e.g., utility rate tables from a utility, user selected rates, home energy management system rates, public service rates, or inferred rates, etc.), battery state and battery charge may be used as inputs to algorithms that establish the charge time interval (within optional customer selected time constraints) that minimizes the cost of battery charging.

In certain greenest charge embodiments, the vehicle charge time may be based on times during which desired energy generation resources (e.g., wind, solar, etc.) are used to generate electricity. As an example, energy generation source information (e.g., utility resource utilization information, home energy management system information, public service information, or inferred information from other data resources, etc.) may be used as input to algorithms that establish the charge time interval (within optional customer selected time constraints) that maximizes the use of “green” generated electricity.

In certain fastest charge embodiments, the vehicle on-plug time may be minimized to provide the fastest charge, given other customer constraints if selected. These algorithms may determine the total time interval over which the customer selected constraints are evaluated. If no other customer constraints are selected, the fastest charge time may be equivalent to a convenience charge time (e.g., the charge time without use of any optimization algorithms).

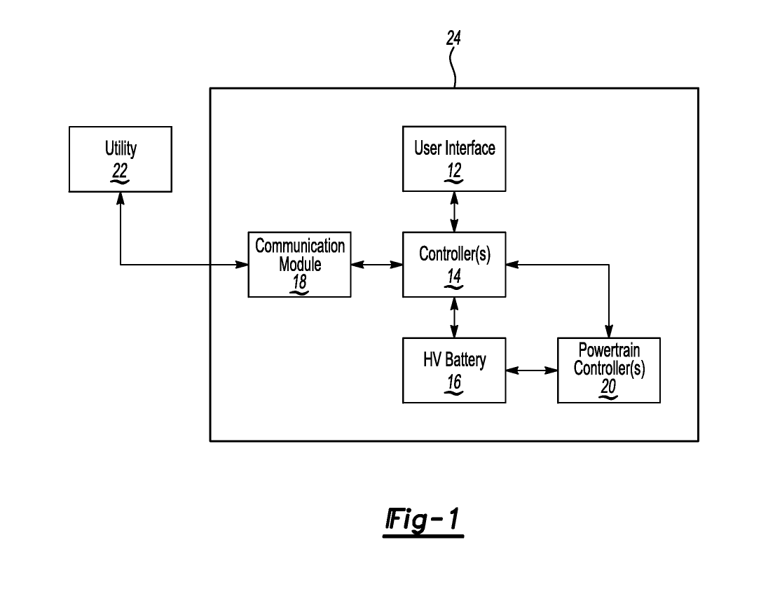

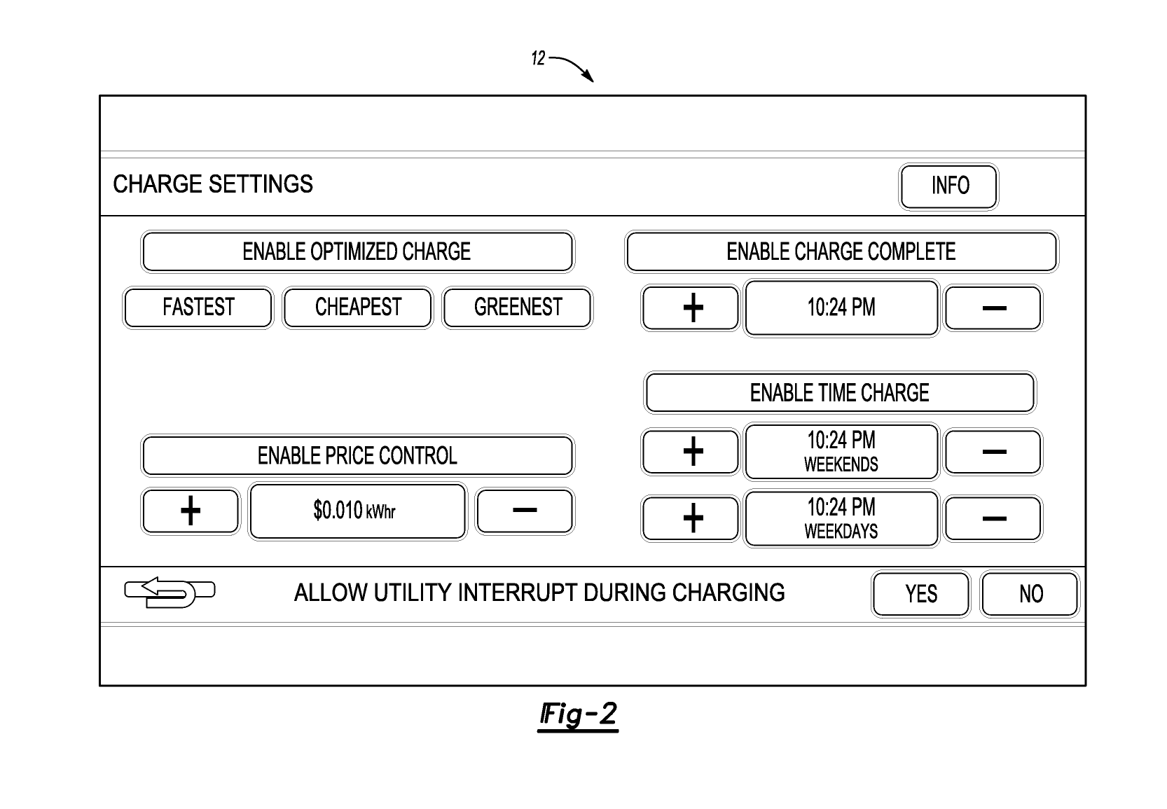

Referring now to FIG. 1, an embodiment of an automotive vehicle 10 (e.g., PHEV, BEV) may include a user interface 12 (e.g., touch screen, buttons, dials, etc.), controller(s) 14, high voltage battery 16 (e.g., traction battery pack, etc.), communications module 18 (e.g., transceiver, power line communications module, etc.), and a powertrain controller(s) 20. The interface 12, battery 16, communications module 18 and powertrain controller(s) 20 are in communication with/under the control of the controller(s) 14. As known in the art, the battery 16 may provide a source of power to move the vehicle 10.

The communications module 18 may communicate with a utility 22 in any suitable/known fashion to obtain, for example, pricing and/or “green” information associated with the energy supplied by the utility. The controller(s) 14 may store this information for later use in determining when to charge the battery 16 as described below.

Tables 1 and 2 list examples of pricing and “green” information that may be acquired by the controller(s) 14.

TABLE 1
Example Pricing and “Green” Utility Information

| TIME | | PEAK | GREEN |
|---|---|---|---|
| 12 | AM | 0 | 0 |
| 1 | AM | 0 | 0 |
| 2 | AM | 0 | 1 |
| 3 | AM | 0 | 1 |
| 4 | AM | 0 | 0 |
| 5 | AM | 0 | 0 |
| 6 | AM | 0 | 0 |
| 7 | AM | 0 | 0 |
| 8 | AM | 1 | 0 |
| 9 | AM | 1 | 0 |
| 10 | AM | 1 | 1 |
| 11 | AM | 1 | 1 |
| 12 | PM | 1 | 1 |
| 1 | PM | 1 | 1 |
| 2 | PM | 1 | 1 |
| 3 | PM | 1 | 1 |
| 4 | PM | 1 | 1 |
| 5 | PM | 1 | 0 |
| 6 | PM | 1 | 0 |
| 7 | PM | 1 | 0 |
| 8 | PM | 1 | 0 |
| 9 | PM | 0 | 0 |
| 10 | PM | 0 | 0 |
| 11 | PM | 0 | 0 |

TABLE 2
Example Pricing and “Green” Utility Information

| | | PRICE | |
|---|---|---|---|
| TIME | | (cents/kWhr) | GREEN |
| 12 | AM | 0.10 | 0 |
| 1 | AM | 0.01 | 0 |
| 2 | AM | 0.01 | 1 |
| 3 | AM | 0.01 | 1 |
| 4 | AM | 0.01 | 0 |
| 5 | AM | 0.05 | 0 |
| 6 | AM | 0.10 | 0 |
| 7 | AM | 0.15 | 0 |
| 8 | AM | 0.20 | 0 |
| 9 | AM | 0.20 | 0 |
| 10 | AM | 0.20 | 1 |
| 11 | AM | 0.20 | 1 |
| 12 | PM | 0.20 | 1 |
| 1 | PM | 0.30 | 1 |
| 2 | PM | 0.40 | 1 |
| 3 | PM | 0.60 | 1 |
| 4 | PM | 0.80 | 1 |
| 5 | PM | 0.50 | 0 |
| 6 | PM | 0.20 | 0 |
| 7 | PM | 0.15 | 0 |
| 8 | PM | 0.15 | 0 |
| 9 | PM | 0.10 | 0 |
| 10 | PM | 0.10 | 0 |
| 11 | PM | 0.10 | 0 |

Each of the tables lists the pricing and “green” information by hour. In Table 1, the pricing and “green” information is presented in binary fashion: with regard to pricing, a “1” indicates expensive energy whereas a “0” indicates cheap energy; with regard to “green,” a “1” indicates energy produced via “green” methods such as solar, wind, etc. whereas a “0” indicates energy produced via traditional techniques such as coal, etc.

Referring now to FIG. 2, an example of the user interface 12 is shown in greater detail. Virtual buttons are provided that permit a user to, for example, specify a charge complete time (“ENABLE CHARGE COMPLETE”), specify a charge start time for weekdays and weekends (“ENABLE TIME CHARGE”), specify a price threshold (“ENABLE PRICE CONTROL”), optimize charge settings (“ENABLE OPTIMIZED CHARGE”: “FASTEST,” “CHEAPEST,” “GREENEST”), permit utility interrupt during charging, and request additional information (e.g., battery state of charge, vehicle information, grid information, etc.) In other embodiments, other and/or different features/options may also be provided.

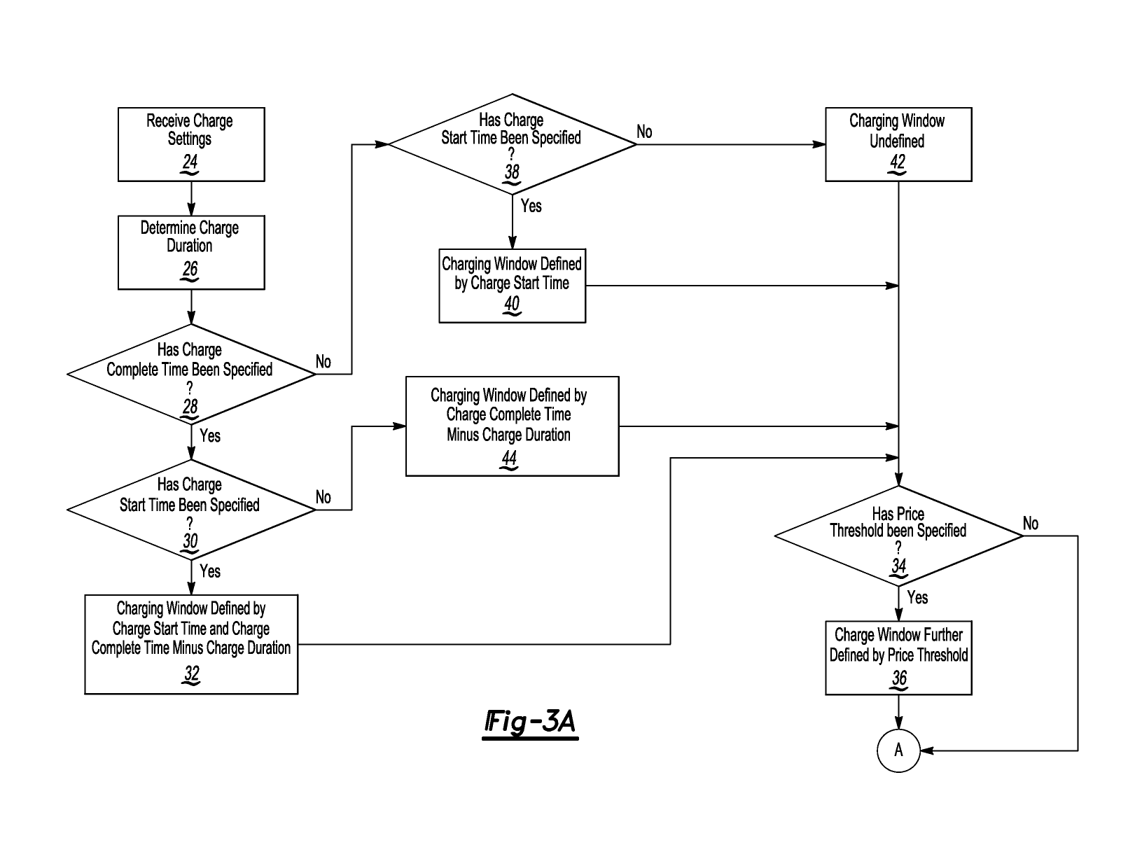

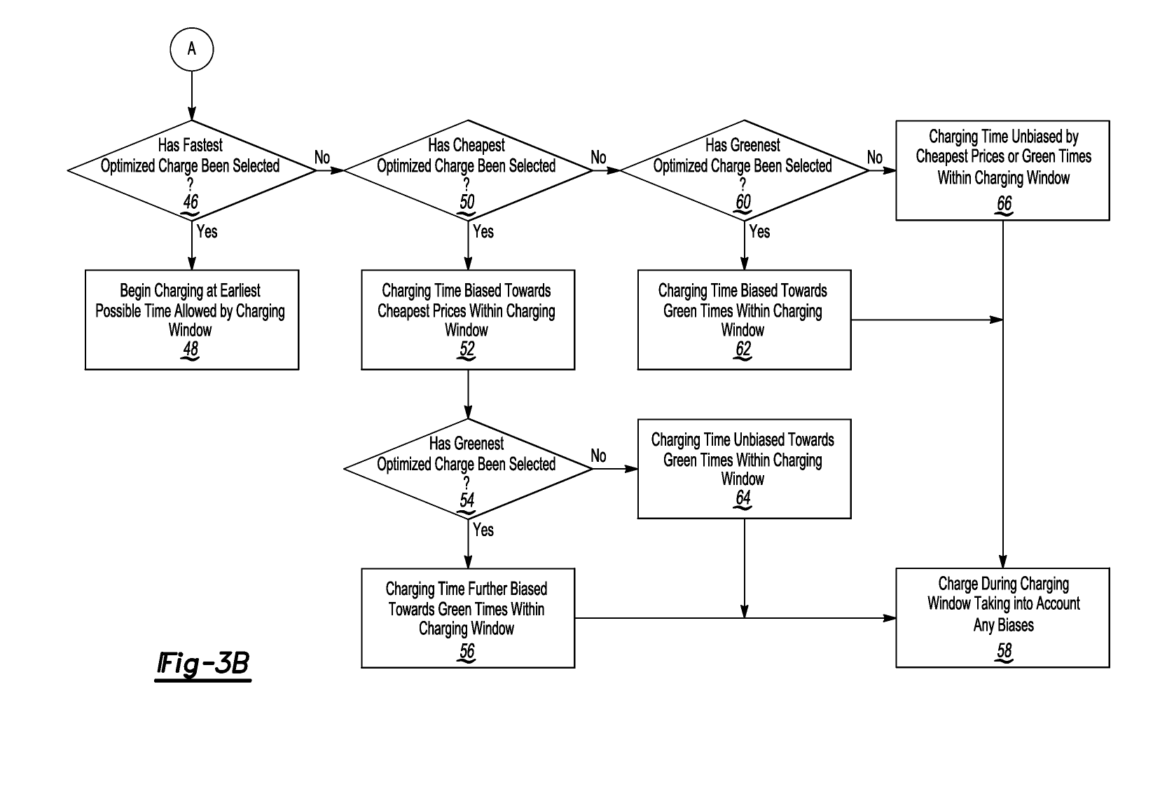

Referring to FIGS. 1 and 3A, charge settings are received at operation 24. For example, the controller(s) 14 may receive information representing the charge settings discussed with reference to FIG. 2. At operation 26, the charge duration is determined. For example, the controller(s) 14 may determine that the duration of time needed to charge the battery 16 (using any suitable/known technique based on for example, current state of charge, desired state of charge, temperature, etc.) is 3 hours. At operation 28, it is determined whether a charge complete time has been specified. For example, the controller(s) 14 may determine that the user has specified a charge complete time of 8 am. That is, the battery 16 must be recharged by 8 am.

If it is determined that a charge complete time has been specified, at operation 30, it is determined whether a charge start time has been specified. For example, the controller(s) 14 may determine that the user has specified a charge start time of 10 pm. That is, the battery 16 cannot begin to be charged until after 10 pm. If it is determined that a charge start time has been specified, the charging window is defined by the charge start time and the charge complete time minus the charge duration at operation 32. For example, the charging window may be between 10 pm (charge start time) and 5 am (8 am-3 hours charge duration).

At operation 34, it is determined whether a price threshold has been specified. For example, the controller(s) 14 may determine that the user has specified that they wish to pay no more than $0.05 per kWhr when the battery 16 is being charged. If it is determined that a price threshold has been specified, the charging window is further defined by the price threshold at operation 36. For example, the controller(s) 14 will charge the battery 16 during the charging window of 10 pm to 5 am mentioned above only when the price is $0.05 per kWhr or less to the extent possible.

Returning to operation 28, if it is determined that a charge complete time has not been specified, at operation 38, it is determined whether a charge start time has been specified. If it is determined that a charge start time has been specified, the charging window is defined by the charge start time at operation 40. That is, the charging window has a specified start time but does not have a specified complete time. If it is determined that a charge start time has not been specified, the charging window is undefined. That is, the charging window does not have a specified start or complete time.

Returning to operation 30, if it is determined that a charge start time has not been specified, the charging window is defined by the charge complete time minus the charge duration at operation 44. That is, the charging window has a specified complete time but does not have a specified start time.

Referring to FIGS. 1, 2 and 3B, it is determined whether the fastest optimized charge has been selected at operation 46. For example, the controller(s) 14 may determine whether the user has selected the “FASTEST” button illustrated in FIG. 2. If it is determined that the fastest optimized charge has been selected, the charging will be begin at the earliest possible time allowed by the charging window at operation 48. For example, if the charging window is 10 pm to 5 am, the charging will begin at 10 pm. If it is determined that the fastest optimized charge has not been selected, at operation 50, it is determined whether the cheapest optimized charge has been selected. For example, the controller(s) 14 may determine whether the user has selected the “CHEAPEST” button illustrated in FIG. 2.

If it is determined that the cheapest optimized charge has been selected, the charging time within the charging window is biased towards the prices cheapest within the charging window at operation 52. For example, referring to Table 2, if the charging window is 10 pm to 5 am, the cheapest prices are from 1 am to 4 am. The controller(s) 14 will schedule to charge the battery 16 during this time.

At operation 54, it is determined whether the greenest optimized charge has been selected. For example, the controller(s) 14 may determine whether the user has selected the “GREENEST” button illustrated in FIG. 2. If it is determined that the greenest optimized charge has been selected, the charging time within the charging window will be further biased towards “green” times within the charging window. For example, referring to Table 2, if the charging window is 10 pm to 5 am and the cheapest prices are from 1 am to 4 am, the “green” times within the 1 am to 4 am time frames are 2 am and 3 am. The controller(s) 14 will further schedule to charge the battery 16 during this time. At operation 58, the battery is charged during the charging window taking into account any biases.

Returning to operation 50, if it is determined that the cheapest optimized charge has not been selected, at operation 60, it is determined whether the greenest optimized charge has been selected. If it is determined that the greenest optimized charge has been selected, the charging time within the charging window will be biased towards “green” times within the charging window at operation 62.

Returning to operation 54, if it is determined that the greenest optimized charge has not been selected, the charging time within the charging window will not be biased towards the “green” times within the charging window at operation 64.

Returning to operation 60, if it is determined that the greenest optimized charge has not been selected, the charging time within the charging window will not be biased towards the cheapest prices or the “green” times within the charging window at operation 66.

The control algorithm of FIGS. 3A and 3B resolved conflicting constraints by prioritizing them. For example, the charge complete time was given the highest priority while the greenest optimized charge was given the lowest priority. The features contemplated herein, however, may be prioritized in any suitable fashion. As an example, the cheapest optimized charge may be given the highest priority, etc. Additionally, other control algorithms may have different and/or other control features. For example, the greenest optimized charge strategy may be the only feature offered, or the cheapest and greenest optimized charge strategies may be the only features offered, etc. Other scenarios and arrangements are also possible.

The algorithms (and/or operations) disclosed herein may be deliverable to a processing device, such as the controller(s) 14, 20 or any other controller(s)/processing device(s) on-board or off-board the vehicle 24, in many forms including, but not limited to, (i) information permanently stored on non-writable storage media such as ROM devices and (ii) information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), state machines, controllers or other hardware components or devices, or a combination of hardware, software and firmware components.

While embodiments of the invention have been illustrated and described, it is not intended that these embodiments illustrate and describe all possible forms of the invention. Rather, the words used in the specification are words of description rather than limitation, and various changes may be made without departing from the spirit and scope of the invention.

What is claimed:

1. A vehicle comprising:
a battery configured to be selectively charged with energy from an off-board energy source; and
at least one controller configured to (i) receive user input specifying a cost minimization mode of battery charging and (ii) in response to the input, determine a time period available for charging the battery, determine when, during the time period, a cost of energy from the off-board energy source is at a minimum or below a threshold cost, and cause the battery to be charged during at least a portion of the time period when the cost is at the minimum or below the threshold cost to minimize the cost of charging the battery.

2. The vehicle of claim 1 wherein the at least one controller is further configured to determine a duration of time needed to charge the battery and to determine a cutoff charge begin time based on the time period and duration of time.

3. The vehicle of claim 2 wherein the at least one controller is further configured to initiate charging of the battery on or before the cutoff charge begin time.

4. The vehicle of claim 1 wherein the time period available for charging the battery is partially defined by a charge complete time and wherein the at least one controller is further configured to determine a duration of time needed to charge the battery, to determine a cutoff charge begin time by subtracting the duration of time needed to charge the battery from the charge complete time and to initiate charging of the battery on or before the cutoff charge begin time.

5. The vehicle of claim 1 wherein the at least one controller is further configured to receive user input specifying a green energy mode of battery charging and, in response to the input specifying the green energy mode of battery charging, to determine when, during the time period, the energy available from the off-board energy source is identified as being green energy.

6. The vehicle of claim 5 wherein the at least one controller is further configured to cause the battery to be charged during at least a portion of the time period when the energy available from the off-board energy source is identified as being green energy.

7. The vehicle of claim 1 wherein the input specifying the cost minimization mode of battery charging further specifies the threshold cost.

8. The vehicle of claim 1 wherein the at least one controller is further configured to receive input specifying at least one of a charge start time and charge complete time and wherein the time period available for charging the battery is determined by the at least one of the charge start time and charge complete time.

9. A vehicle comprising:
a battery configured to be selectively charged with energy from an off-board energy source; and
at least one controller configured to (i) receive user input specifying a green energy mode of battery charging and (ii) in response to the input, determine a time period available for charging the battery, determine when, during the time period, energy available from the off-board energy source is identified as being green energy, and cause the battery to be charged during a least a portion of the time period when the energy available from the off-board energy source is identified as being green energy.

10. The vehicle of claim 9 wherein the at least one controller is further configured to determine a duration of time needed to charge the battery and to determine a cutoff charge begin time based on the time period and duration of time.

11. The vehicle of claim 10 where in the at least one controller is further configured to initiate charging of the battery on or before the cutoff charge begin time.

12. The vehicle of claim 9 wherein the time period available for charging the battery is partially defined by a charge complete time and wherein the at least one controller is further configured to determine a duration of time needed to charge the battery, to determine a cutoff charge begin time by subtracting the duration of time needed to charge the battery from the charge complete time and to initiate charging of the battery on or before the cutoff charge begin time.

13. The vehicle of claim 9 wherein the at least one controller is further configured to receive user input specifying a cost minimization mode of battery charging and, in response to the input specifying the cost minimization mode of battery charging, to determine when, during the time period, a cost of energy from the off-board energy source is at a minimum or below a threshold cost.

14. The vehicle of claim 13 wherein the at least one controller is further configured to cause the battery to be charged during at least a portion of the time period when the cost is at the minimum or below the threshold cost.

15. The vehicle of claim 13 wherein the input specifying the cost minimization mode of battery charging further specifies the threshold cost.

16. The vehicle of claim 9 wherein the at least one controller is further configured to receive input specifying at least one of a charge start time and charge complete time and wherein the time period available for charging the battery is determined by the at least one of the charge start time and charge complete time.

17. A vehicle comprising:
a battery configured to be selectively charged with energy from an off-board energy source; and
at least one controller configured to (i) receive user input specifying a fast mode of battery charging and (ii) in response to the input, determine a time period available for charging the battery and initiate charging of the battery at the beginning of the time period.

18. The vehicle of claim 17 wherein the at least one controller is further configured to receive input specifying at least one of a charge start time and charge complete time and wherein the time period available for charging the battery is determined by the at least one of the charge start time and charge complete time.

19. A method for charging a vehicle battery with energy from an off-board energy source comprising:
receiving input specifying a cost minimization mode of battery charging; and
in response to the input,
determining a time period available for charging the battery,
determining when, during the time period, a cost of energy from the off-board energy source is at a minimum or below a threshold cost, and
causing the battery to be charged during at least a portion of the time period when the cost is at the minimum or below the threshold cost to minimize the cost of charging the battery.

20. The method claim 19 further comprising
receiving user input specifying a green energy mode of battery charging and,
in response to the input specifying the green energy mode of battery charging,
determining when, during the time period, the energy available from the off-board energy source is identified as being green energy, and
causing the battery to be charged during at least a portion of the time period when the energy available from the off-board energy source is identified as being green energy.
